(19) United States
(12) Patent Application Publication
(10) Pub. No.: US 2006/0104419 A1
(43) Pub. Date: May 18, 2006

(54) Superconducting X-ray analyzer

(76) Inventors: Norio Sasayama, Chiba-shi (JP); Keiichi Tanaka, Chiba-shi (JP)

Correspondence Address: ADAMS & WILKS, 17 BATTERY PLACE, SUITE 1231, NEW YORK, NY, 10004, US

(21) Appl. No.: 11/066,034

(22) Filed: Feb. 25, 2005

(30) Foreign Application Priority Data
Mar. 10, 2004 (JP) 2004-066712

(51) Int. Cl. G21K 1/00

(52) U.S. Cl. 378/145

(57) ABSTRACT

A superconducting X-ray analyzer has an excitation source for irradiating an excitation beam on a surface of a sample. A detector detects X-rays reflected from the surface of the sample irradiated with the excitation beam from the excitation source. Lenses are arranged between the sample and the detector for condensing the X-rays reflected from the surface of the sample on the detector. A refrigerator having a low temperature unit is completely enclosed within a vacuum vessel for cooling the detector.

### BACKGROUND OF THE INVENTION 1. Field Of The Invention

This invention relates to a superconducting X-ray analyzer, and more particularly to a superconducting X-ray analyzer adapted to detect X-rays, which diverge from a sample, by condensing the same through a lens or lenses for X-rays, and analyze the resultant X-rays. 2. Description of the Related Art

A superconducting X-ray analyzer utilizes a refrigerator for cooling a superconducting detector like STJ and TES to an extremely low temperature. STJ is a superconducting tunnel junction detector. TES is a transition edge sensor. A detector-mounted extremely low temperature unit is enclosed with a plurality of heat shielding walls having an intermediate temperature between room temperature and an extremely low temperature so as to hold down a flow of heat from the outside there into; and placed in a vacuum environment. The detector has an extremely small detection area of smaller than 1 mm². In a related art analyzer, a detector-mounted extremely low temperature unit is drawn out narrowly from a refrigerator and brought close to a sample (refer to, for example, FIGS. 6 and 7 of a non-patent document “High-resolution energy-dispersive micro-calorimeter spectrometer for X-ray micro-analysis ” Journal of Microscopy, V188, Issue 03, Page 196, December, 1997, written by D. A. Wollman et al) so as to improve a detector efficiency by widely taking in the X-rays diverging from the sample, i.e., so as to enlarge a solid angle formed when the detection area of the detector viewed from the sample.

This related art example will now be described by using FIG. 7. FIG. 7 is a drawing showing the schematic construction of the related art superconducting X-ray analyzer not using a lens for X-rays.

Referring to FIG. 7, out of the X-rays diverging from a sample 6, only the X-rays that are in an optical path 7 are detected by a detector 5. An extremely low temperature unit 4 is enclosed with a 4K heat shield 3, an 80K heat shield 2 and a vacuum vessel 1, and all of them are drawn out in the form of projections so as to bring the detector 5 close to the sample 6. In order to bring the detector-mounted extremely low temperature unit close to the sample and prevent the refrigerator from interfering with an excitation source 12, a sample vessel 17 and sample 6, such a structure is employed. This excitation source 12 is an electron gun, and an electron beam 13 is applied to one point on a surface of the sample. Moreover, a structure for further improving a detector efficiency by using one lens for X-rays having both-side focuses on an analysis point of the sample and a position of the detector (refer to, for example, FIG. 30 of the non-patent document 1).

This related art example will be described by using FIG. 8. FIG. 8 is a drawing schematically showing the construction of a related art superconducting X-ray analyzer using a lens for X-rays.

Referring to FIG. 8, a lens 8 for X-rays is provided between a sample 6 and a detector 5. Out of the X-rays diverging from the sample 6, the portions thereof which are in optical paths 7 are detected by the detector 5. In comparison with the solid angle in the example of FIG. 7, it is understood that the solid angle in the example of FIG. 8 formed when the optical paths 7 are viewed from the sample is larger, and that the detector efficiency is improved.

In the specification of the present invention, all of the elements for varying the optical path of the X-rays, such as a mirror and a diffraction grating besides an optical element having a light condensing function are called lens for X-rays. Both an analyzer having an electron gun or an X-ray source as excitation sources for radiating X-rays from an analysis point on a sample, and an analyzer not having an excitation source so that the analyzer is mounted on another apparatus having these excitation sources and used in practice are called superconducting X-ray analyzers.

In a related art analyzer in which an extremely low temperature unit is drawn out from a refrigerator and brought close to a sample, structures for holding down the inflow of heat, such as heat shielding walls and a vacuum environment became obstacle to an operation for bringing a detector close to the sample. In a related art structure utilizing one lens for X-rays, setting the detector far from the sample is possible but a large lens for X-rays has to be used for separating the detector from the sample. Therefore, it was difficult to set the sample and detector sufficiently away from each other, so that drawing out the extremely low temperature unit from a refrigerator was necessary. Since the extremely low temperature unit drawn out from the refrigerator is mechanically and thermally unstable, it posed problems concerning the accuracy of position of the detector and the occurrence of signal noises. Granting that the sample and detector could be set somehow away from each other sufficiently in a related art structure using one lens for X-rays, X-ray lenses of different focal distances have to be used when a distance between the sample and detector is changed.

### SUMMARY OF THE INVENTION

The present invention aims at providing a superconducting X-ray analyzer capable of solving these problems; detecting X-rays efficiently without drawing out an extremely low temperature unit from a refrigerator; and using the same lenses for X-rays irrespective of a distance between a sample and a detector.

In order to solve the above-mentioned problems, the superconductive X-ray analyzer according to the present invention is provided with two lenses for X-rays positioned between a sample and a detector so that the sample, a lens for X-rays, another lens for X-rays and the detector are disposed in the mentioned order. The sample-side lens for X-rays is disposed so that the focus thereof is on the sample, while the detector-side lens for X-rays is disposed so that the focus thereof in on the detector, in such a manner that the X-rays diverging from the sample pass through the two lenses for X-rays and are condensed by the detector.

The two lenses for X-rays are disposed so that the X-rays running there between become close to parallel rays, and it is desirable that a case where a distance between the sample and detector is different be dealt with by changing only a distance between the two lenses for X-rays with a distance between the sample-side lens for X-rays and sample and that between the detector-side lens for X-rays and detector left fixed.

It is desirable that two polycapillary type lenses for X-rays one side of which accepts parallel rays are used.

It is possible to replace the sample-side lens for X-rays with a plurality of lenses for X-rays, or replace the detector-side lens for X-rays with a plurality of lenses for X-rays.

When two lenses for X-rays are provided between the sample and detector in the above-mentioned manner, the X-rays diverging from the sample are angle-converted in the following manner to reach the detector. First the X-rays diverging from the sample are caught at a wide solid angle by the sample-side lens for X-rays, and the divergence angle is converted into a low level, the resultant X-rays advancing toward the detector-side lens for X-rays. The X-rays are then condensed toward the detector by the detector-side lens for X-rays.

When a divergence angle or a condensation angle of the X-rays between the two lenses for X-rays is smaller than and closer to that of parallel rays, the variation in an X-ray transportation efficiency due to the changing of a distance between the two lenses for X-rays is more held down.

When polycapillary type lenses for X-rays one side of which accepts the parallel rays are used, the X-rays between the two lenses for X-rays become always parallel without receiving the influence of a distance between the sample-side lens for X-rays and sample and that between the detector-side lens for X-rays and detector.

When the sample-side lens for X-rays is replaced suitably with a plurality of lenses for X-rays, or when the detector-side lens for X-rays is replaced suitably with a plurality of lenses for X-rays, these lenses constitute means for further optimizing the forms of optical paths for the X-rays.

The superconducting X-ray analyzer according to the present invention is practiced in the above-described mode, and has the effect which will be described below.

Since two lenses for X-rays are used instead of one lens for X-rays, it becomes easy to employ a structure in which the sample and detector are separated far away from each other, so that it becomes unnecessary to draw out in the form of a projection the detector-mounted extremely low temperature unit from a refrigerator. This enables the extremely low temperature unit to be mechanically and thermally stabilized, and an apparatus having much less problems concerning the position accuracy of the detector and the occurrence of signal noises to be attained.

The variation in the transportation efficiency of X-rays occurring when the distance between the two lenses for X-rays is changed can be held down by setting the X-rays between the two lenses close to parallel rays, and a case where a distance between the sample and detector is different can also be dealt with by only changing the distance between the two lenses for X-rays while retaining a detector efficiency.

Since the polycapillary type lenses for X-rays one side of which accepts the parallel rays are used, X-rays as parallel rays can be obtained without making efforts to regulate a divergence angle or a condensation angle of the X-rays between the two lenses for X-rays. At the same time, even when a distance between the sample-side lens for X-rays and sample, or a distance between the detector-side lens for X-rays and detector changes, the X-rays between the two lenses can always be maintained as parallel rays.

When the sample-side lens for X-rays is suitably replaced with a plurality of lenses for X-rays, or when the detector-side lens for X-rays is suitably replaced with a plurality of lenses for X-rays, suitable focal size and the depth of focus, for correction of the aberration of the X-ray optical paths, or reduction of the apparatus size can be obtained.

### BRIEF DESCRIPTION OF THE DRAWING

FIG. 1 is a construction diagram showing a first mode of example of a principal portion of the superconducting X-ray analyzer according to the present invention;

FIG. 2 is a construction diagram showing a second mode of example of a principal portion of the superconducting X-ray analyzer according to the present invention;

FIG. 3 is a construction diagram showing a third mode of example of a principal portion of the superconducting X-ray analyzer according to the present invention;

FIG. 4 is a construction diagram showing a fourth mode of example of a principal portion of the superconducting X-ray analyzer according to the present invention;

FIG. 5 is a construction diagram showing a first embodiment of the superconducting X-ray analyzer according to the present invention;

FIG. 6 is a construction diagram showing a second embodiment of the superconducting X-ray analyzer according to the present invention;

FIG. 7 is a drawing showing a related art example not using a lens for X-rays; and

FIG. 8 is a drawing showing a related art example using a lens for X-rays.

### DESCRIPTION OF THE PREFERRED EMBODIMENTS

The modes of embodiments of the present invention will be described with reference to the drawings. The following modes of embodiments shall not limit the present invention. In practice, a plurality of kinds of structures having identical functions can be obtained by changing the kinds, combinations and arrangement of the lenses for X-rays.

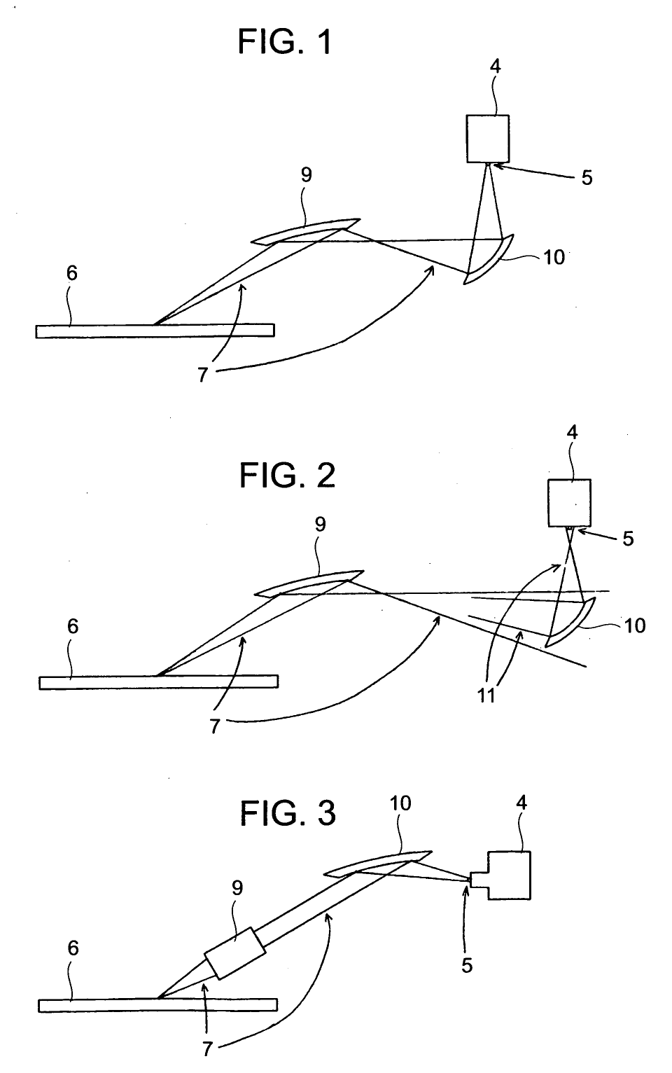

FIG. 1 is a construction diagram showing a first mode of example of a principal portion of the superconducting X-ray analyzer according to the present invention, in which an example of the arrangement of two lenses for X-rays, a sample and a detector, and optical paths of the X-rays passing among these parts are shown. The X-rays diverging from a sample 6 are taken widely in a lens 9 for X-rays, and condensed on a detector 5 by a lens 10 for X-rays.

FIG. 2 is a construction diagram showing a second mode of example of a principal portion of the superconducting X-ray analyzer according to the present invention, in which a detector is farther from a sample than the example of FIG. 1 with the same two lenses for X-rays as are used in the example of FIG. 1. As compared with the example of FIG. 1, only the distance between the two lenses for X-rays is increased with the positional relation between the sample-side lens for X-rays and a sample and the positional relation between the detector-side lens for X-rays and a detector left as they are. Out of the X-rays included in an X-ray path 7, only the portions thereof that are included in an X-ray path 11 are condensed toward a detector 5. Since the focus of the detector-side lens for X-rays is out of place, only some of the X-rays reach the detector. Thus, some of the X-rays passing through the sample-side lens for X-rays are lost, and do not reach the detector. FIG. 2 shows the condition in which the X-ray transportation efficiency thus decreases as compared with that in the example of FIG. 1.

FIG. 3 is a construction diagram showing a third mode of example of a principal portion of the superconducting X-ray analyzer according to the present invention, in which a second example of the arrangement of two lenses for X-rays, a sample and a detector, and optical paths of the X-rays passing through these parts are shown. The X-rays between a lens 9 for X-rays and a lens 10 for X-rays are close to parallel rays. Therefore, even when this structure is applied to a case where a distance between the sample and detector is set different by changing only the distance between the two lenses for X-rays, the condition of the example of FIG. 2 with respect to that of the example FIG. 1 is not seen, i.e., a decrease in the X-ray transportation efficiency does not occur.

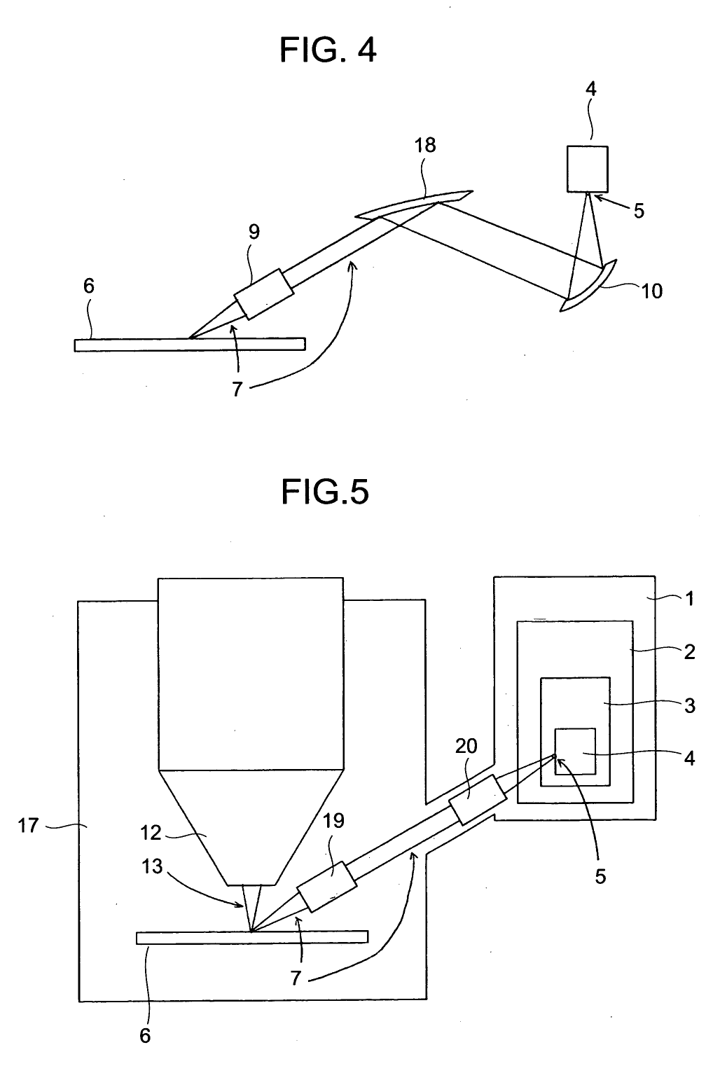

FIG. 4 is a construction diagram showing a fourth mode of example of a principal portion of the superconducting X-ray analyzer according to the present invention, in which an example of the arrangement of more than two lenses for X-rays, a sample and a detector, optical paths of the X-rays passing through these parts. The portion of the X-rays which are between a lens 9 for X-rays and a lens 18 for X-rays are close to parallel rays. Therefore, even when this structure is applied to a case where a distance between a sample and a detector is set different by changing only the distance between these two lenses for X-rays, the X-ray transportation efficiency does not decrease. The lens 18 for X-rays is adapted to convert the X-rays coming from the sample into the condition in which the lens 10 for X-rays functions optimumly.

### EMBODIMENTS

The embodiments of the superconducting X-ray analyzer according to the present invention will be described with reference to the drawings. The following embodiments shall not limit the present invention. In practice, a plurality of kinds of structures having identical functions can be obtained by changing the kinds, combinations and arrangement of the lenses for X-rays, or by providing or not providing an excitation source, and changing the kinds of the excitation source.

FIG. 5 is a construction diagram showing a first embodiment of the superconducting X-ray analyzer according to the present invention. In this embodiment, an electron beam is used as an excitation source 12, and a vacuum space in a vacuum vessel 1 for a refrigerator and that in a sample vessel 17 are provided so that these vacuum spaces communicate with each other. Out of the X-rays diverging from a sample 6, only such portions thereof that are included in an optical path 7 are detected by a detector 5. An extremely low temperature unit 4 is enclosed with a 4K heat shield 3 and a 80K heat shield 2, and all of them are housed in the interior of the vacuum vessel 1 of the refrigerator. The X-rays between a sample-side polycapillary type lens 19 for X-rays and a detector-side polycapillary type lens 20 for X-rays are parallel X-rays. Therefore, even when the vacuum vessel 1 for the refrigerator has to be far from the sample due to the large-sized excitation source 12, sample vessel 17, or sample 6, this problem can be solved by only enlarging a distance between the sample-side polycapillary type lens 19 for X-rays and detector-side polycapillary type lens 20 for X-rays.

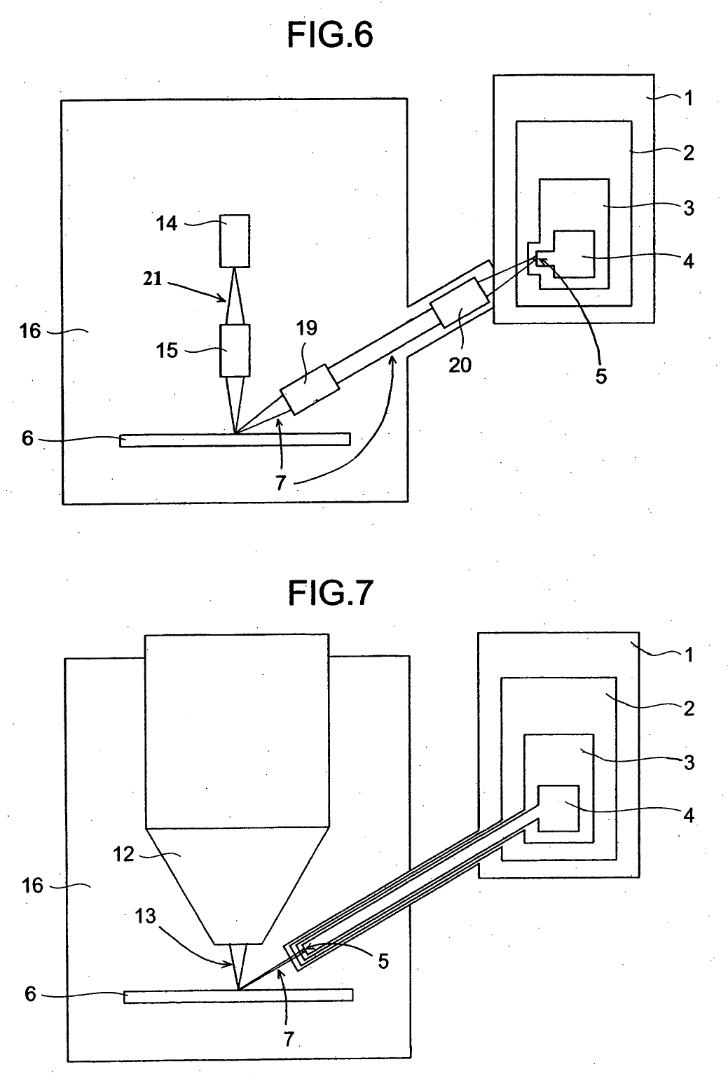

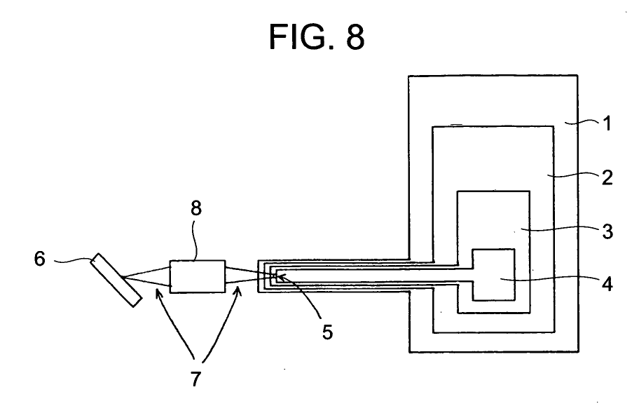

FIG. 6 is a construction diagram showing a second embodiment of the superconducting X-ray analyzer according to the present invention. In this embodiment, an X-ray tube is used as an excitation source 14, and a third lens 15 for X-rays is also used to efficiently apply X-rays 21 diverging from the X-ray tube to an analyzed point on a sample 6. A radiation protecting sample vessel 16 is not formed so as to have a vacuum environment. Therefore, unlike the sample vessel in the embodiment of FIG. 5, a vacuum vessel 1 is closed with a refrigerator only. Housing an extremely low temperature unit in the interior of the vacuum vessel 1, and the easiness of a change of design of parts made when the size of the sample is large are identical as in the case of the embodiment of FIG. 5.

1. A superconducting X-ray analyzer comprising: an excitation source for irradiating an excitation beam on a surface of a sample; a detector for detecting X-rays reflected from the surface of the sample irradiated with the excitation beam from the excitation source; a plurality of lenses for condensing the X-rays reflected from the surface of the sample on the detector, the lenses being arranged between the sample and the detector so that the sample, the lenses and the detector are arranged in a row, one of the lenses being disposed closer to the sample than to the detector to focus the X-rays on the sample, and another one of the lenses being disposed closer to the detector than to the sample to focus the X-rays on the detector; a vacuum vessel; and a refrigerator having a low temperature unit completely enclosed within the vacuum vessel for cooling the detector.

2. A superconducting X-ray analyzer according to claim 1; wherein the sample, the lenses and the detector are arranged so that the X-rays condensed by two adjacent lenses are substantially parallel to one another.

3. A superconducting X-ray analyzer according to claim 1; wherein the plurality of lenses comprises two lenses.

4. A superconducting X-ray analyzer according to claim 3; wherein the two lenses are adjacent one another; and wherein the sample, the two lenses and the detector are arranged so that the X-rays condensed by the two adjacent lenses are substantially parallel to one another.

5. A superconducting X-ray analyzer according to claim 4; wherein each of the lenses comprises a polycapillary-type lens having one side for receiving the parallel X-rays.

6. A superconducting X-ray analyzer according to claim 2; further comprising means for varying an optical path length between the two adjacent lenses.

7. A superconducting X-ray analyzer according to claim 2; wherein the two adjacent lenses are movable relative one another to adjust an optical path length between the adjacent lenses.

8. A superconducting X-ray analyzer according to claim 2; wherein each of the lenses comprises a polycapillary-type lens having one side for receiving the parallel X-rays.

9. A superconducting X-ray analyzer according to claim 4; further comprising means for varying an optical path length between the two adjacent lenses.

10. A superconducting X-ray analyzer according to claim 4; wherein the two adjacent lenses are movable relative one another to adjust an optical path length between the adjacent lenses.

11. A superconducting X-ray analyzer comprising:
an excitation source for irradiating an excitation beam on a surface of a sample;
a detector for detecting X-rays reflected from the surface of the sample irradiated with the excitation beam from the excitation source;
a plurality of lenses for focusing the X-rays reflected from the surface of the sample on the detector;
a vacuum vessel containing the detector; and
a refrigerator having a low temperature unit completely enclosed within the vacuum vessel for cooling the detector.

12. A superconducting X-ray analyzer according to claim 11; wherein the plurality of lenses comprises two lenses disposed adjacent one another; and wherein the sample, the two adjacent lenses and the detector are arranged so that the X-rays condensed by the two adjacent lenses are substantially parallel to one another.

13. A superconducting X-ray analyzer according to claim 12; wherein each of the two adjacent lenses comprises a polycapillary-type lens having one side for receiving the parallel X-rays.

14. A superconducting X-ray analyzer according to claim 12; wherein the two adjacent lenses are disposed between the sample and the detector; and further comprising a third lens disposed between the excitation source and the surface of the sample for focusing the excitation beam from the excitation source on the surface of the sample.

15. A superconducting X-ray analyzer according to claim 11; wherein the plurality of lenses comprises two lenses disposed adjacent one another and between the sample and the detector.

16. A superconducting X-ray analyzer according to claim 15; wherein each of the two adjacent lenses comprises a polycapillary-type lens.

17. A superconducting X-ray analyzer comprising:
a first vacuum chamber for containing a sample;
an excitation source disposed in the first vacuum chamber for irradiating an excitation beam on a surface of the sample;
a second vacuum chamber in communication with the first vacuum chamber to provide a common vacuum environment;
a detector disposed in the second vacuum chamber for detecting X-rays reflected from the surface of the sample irradiated with the excitation beam from the excitation source;
a plurality of lenses disposed in the vacuum environment for focusing the X-rays reflected from the surface of the sample on the detector;
a vacuum vessel containing the detector; and
a low temperature unit completely enclosed within the second vacuum vessel for cooling the detector.

18. A superconducting X-ray analyzer according to claim 17; wherein the plurality of lenses comprises two lenses disposed adjacent one another; and wherein the sample, the adjacent lenses and the detector are arranged so that the X-rays condensed by the two adjacent lenses are substantially parallel to one another.

19. A superconducting X-ray analyzer according to claim 18; wherein each of the two adjacent lenses comprises a polycapillary-type lens having one side for receiving the parallel X-rays.

20. A superconducting X-ray analyzer according to claim 18; wherein the two adjacent lenses are disposed between the sample and the detector; and further comprising a third lens disposed between the excitation source and the surface of the sample for focusing the excitation beam from the excitation source on the surface of the sample.
